(19) United States
(12) Patent Application Publication
(10) Pub. No.: US 2026/0303649 A1
(43) Pub. Date: Oct. 1, 2026

(54) LAYERED ARCHITECTURE FOR EXTENSIBLE AGENT AND SECURE COMPUTATION FRAMEWORK

(71) Applicant: NBHD.AI, INC., Baltimore, MD (US)

(72) Inventors: Stephen CATTELL, Baltimore, MD (US); James ASHWORTH, Arlington, VA (US)

(73) Assignee: NBHD.AI, INC., Baltimore, MD (US)

(21) Appl. No.: 19/630,024

(22) Filed: Mar. 26, 2026

Related U.S. Application Data
(60) Provisional application No. 63/779,152, filed on Mar. 27, 2025.

(51) Int. Cl. H04L 9/40

(52) U.S. Cl. CPC H04L 63/1433

(57) ABSTRACT

Systems and methods for layered security testing and Artificial Intelligence (AI) evaluation are disclosed. A system can instantiate an executor configured to orchestrate execution of layers and capabilities. The system can determine the layers, the layers comprising user-defined logic configured for execution in a sandbox environment. The system can determine the capabilities, the capabilities comprising executable code configured to provide controlled access to at least one external resource. The system can generate a pipeline linking at least one of the layers with at least one of the capabilities. The system can transmit, via the pipeline, a call from at least one of the layers to at least one of the capabilities. The system can generate an interface between the layers and at least one external resource, the interface configured to mediate access through the capabilities. The system can generate logging data associated with execution of the pipeline.

### CROSS-REFERENCE TO RELATED APPLICATIONS

This application claims priority to U.S. Provisional Patent Application Ser. No. 63/779,152, filed Mar. 27, 2025, which is incorporated by reference in its entirety.

### BACKGROUND

Security testing frameworks can provide extensible environments for evaluating the robustness of software systems and artificially intelligent models against adversarial inputs and attack scenarios. Such frameworks can employ modular components that are dynamically loaded and chained together, testing logic and system resource access can be combined into configurable sequences. However, coupling testing logic with system resource access in a unified execution environment creates challenges in maintaining security boundaries, providing safe contribution of user-defined modules, and supporting reuse of components across varied testing scenarios.

### SUMMARY

Security testing and artificial intelligence (AI) evaluation can involve constructing sequences of interdependent operations that interact with external systems, specialized hardware, and remote services. Modular testing platforms can provide a platform to users to dynamically load and chain independent components, creating customized attack sequences targeted at particular systems under evaluation. However, conventional modular testing platforms couple user-defined logic directly with the execution capabilities that perform operations on external resources, resulting in a single execution environment where user-authored code can access system resources without restriction. The absence of a defined boundary between user logic and system resource access creates challenges in allowing third-party or user-submitted code to execute safely, in reusing components across different testing scenarios, and in supporting open evaluation environments where untrusted contributors can participate without exposing the underlying system to abuse.

The techniques described herein can address the above limitations by separating user-defined logic from system resource access through a layered architecture in which an executor can orchestrate execution of distinct layer and capability components. The executor can load layer components containing user-defined logic for execution in a sandbox environment, where the sandbox environment can restrict direct access to external resources. The techniques described herein can expose external resources to sandboxed layer components through capability components that provide defined call interfaces, such that layer components can influence external systems through limited and controlled connections. In some implementations, capability components can enforce access restrictions, such as rate limiting or call count limits, that are embedded in the capability and are not editable through the user-defined layer. The techniques described herein can support configuration of pipelines through structured definition files that specify input mappings, output mappings, and source locations for layers and capabilities, allowing the same pipeline definition to be reused across command-line, server, and distributed execution environments.

In one embodiment, a system for layered security testing and Artificial Intelligence (AI) evaluation may comprise at least one processing resource; and a computer-readable medium storing instructions that, when executed by the at least one processing resource, may cause the system to: instantiate an executor configured to orchestrate execution of a plurality of layers and a plurality of capabilities; determine the plurality of layers, the plurality of layers comprising user-defined logic configured for execution in a sandbox environment and defining at least one of security test logic and AI evaluation logic; determine the plurality of capabilities, the plurality of capabilities comprising executable code configured to provide controlled access to at least one of a plurality of external resources; generate a pipeline linking at least one of the plurality of layers with at least one of the plurality of capabilities according to configuration data defining input mappings, output mappings, and transport data; transmit, via the pipeline, a call from at least one of the plurality of layers to at least one of the plurality of capabilities; generate an interface between the plurality of layers and at least one of the plurality of external resources, the interface configured to mediate access through the plurality of capabilities; and generate logging data associated with execution of the pipeline.

In some aspects, instantiating the executor may include: retrieving at least one of the plurality of layers and at least one of the plurality of capabilities from one or more repositories; determining binary signature data associated with at least one of the plurality of layers and at least one of the plurality of capabilities; and authorizing execution of at least one of the plurality of layers and at least one of the plurality of capabilities based at least on the binary signature data.

In some aspects, determining the plurality of layers may include: identifying user-defined logic written in at least one programming language; generating, based on the user-defined logic, a compiled representation configured for execution in the sandbox environment; and transmitting, to the pipeline, the compiled representation for execution in the pipeline.

In some aspects, determining the plurality of layers may further include: identifying a first layer configured for execution in the sandbox environment and a second layer configured for native execution; selecting the first layer for a first execution context associated with a first security level; and selecting the second layer for a second execution context associated with a second security level, wherein the second security level is lower than the first security level.

In some aspects, determining the plurality of capabilities may include: identifying a first capability configured for local execution by dynamic loading in the executor; identifying a second capability configured for remote execution through a communication channel to at least one of a remote server and a remote executor; and selecting the first capability or the second capability according to the transport data.

In some aspects, generating the pipeline may include: identifying, based on the configuration data, a first layer, a second layer, and a first capability; mapping an output of the first layer to an input of the first capability according to the input mappings; mapping an output of the first capability to an input of the second layer according to the output mappings; and linking the first layer, the first capability, and the second layer in a processing sequence.

In some aspects, transmitting the call via the pipeline may include: generating a remote procedure call from at least one of the plurality of layers to at least one of the plurality of capabilities; serializing data associated with the remote procedure call according to a serialization format; and communicating the serialized data according to a transport specified by the transport data.

In some aspects, generating the interface may include: transmitting, to the plurality of layers, a defined call interface associated with the plurality of capabilities; providing, via the plurality of capabilities, based on the defined call interface, access to at least one of the plurality of external resources; and preventing access by the plurality of layers to the plurality of external resources outside the defined call interface.

In some aspects, the executor may be further configured to manage execution of the pipeline by: executing at least one execution control including at least one of rate limiting, load balancing, and access restriction to a call directed to at least one of the plurality of capabilities; verifying authorization associated with access to at least one of the plurality of layers or at least one of the plurality of capabilities; and determining debugging data associated with execution of the pipeline.

In some aspects, the plurality of capabilities may include executable code configured to provide controlled access to at least one resource, and wherein generating logging data further includes correlating activity of the executor, the plurality of layers, and the plurality of capabilities.

In some aspects, the executor may be further configured to: generate a second pipeline; expose the second pipeline to at least one of the plurality of layers through a pipeline call interface; and execute the second pipeline in response to a call from at least one of the plurality of layers.

In another embodiment, a method for layered security testing and Artificial Intelligence (AI) evaluation may include: instantiating an executor configured to orchestrate execution of a plurality of layers and a plurality of capabilities; determining the plurality of layers, the plurality of layers including user-defined logic configured for execution in a sandbox environment and defining at least one of security test logic and AI evaluation logic; determining the plurality of capabilities, the plurality of capabilities including executable code configured to provide controlled access to at least one of a plurality of external resources; generating a pipeline linking at least one of the plurality of layers with at least one of the plurality of capabilities according to configuration data defining input mappings, output mappings, and transport data; transmitting, via the pipeline, a call from at least one of the plurality of layers to at least one of the plurality of capabilities; generating an interface between the plurality of layers and at least one of the plurality of external resources, the interface configured to mediate access through the plurality of capabilities; and generating logging data associated with execution of the pipeline.

In some aspects, determining the plurality of layers may include: receiving user-defined logic through an interface associated with an evaluation environment; identifying the user-defined logic as logic written in at least one programming language; generating, based on the user-defined logic, a compiled representation configured for execution in the sandbox environment; and transmitting, to the pipeline, the compiled representation for execution in the pipeline.

In some aspects, generating the pipeline may include: receiving a pipeline definition in a configuration format; identifying, from the pipeline definition, source data associated with at least one of the plurality of capabilities; replacing the source data with host data associated with a remote server; and executing the pipeline with the remote server while maintaining at least one of the plurality of layers in the pipeline.

In some aspects, the method may further include: executing the pipeline in a command-line interface environment; receiving input data from a command-line invocation; and generating result data associated with execution of the pipeline in the command-line interface environment.

In some aspects, the method may further include: executing the pipeline in a server environment; determining data from a storage mechanism for processing by the pipeline; and generating result data associated with execution of the pipeline in the server environment.

In some aspects, the method may further include: generating a second pipeline; exposing the second pipeline to at least one of the plurality of layers through a pipeline call interface; and executing the second pipeline in response to a call from at least one of the plurality of layers.

In some aspects, determining the plurality of capabilities may include determining a capability configured to provide access to a large language model, and wherein mediating access includes: limiting a number of calls from user-defined logic to the capability configured to provide access to the large language model to a single call during execution of the pipeline; and limiting an amount of input data provided to the capability configured to provide access to the large language model to fewer than a limit of characters during execution of the pipeline.

In yet another embodiment, a non-transitory, computer-readable medium may include instructions that, when executed by at least one processing resource, cause the at least one processing resource to: instantiate an executor configured to orchestrate execution of a plurality of layers and a plurality of capabilities; determine the plurality of layers, the plurality of layers including user-defined logic configured for execution in a sandbox environment and defining at least one of security test logic and Artificial Intelligence (AI) evaluation logic; determine the plurality of capabilities, the plurality of capabilities including executable code configured to provide controlled access to at least one of a plurality of external resources; generate a pipeline linking at least one of the plurality of layers with at least one of the plurality of capabilities according to configuration data defining input mappings, output mappings, and transport data; transmit, via the pipeline, a call from at least one of the plurality of layers to at least one of the plurality of capabilities; generate an interface between the plurality of layers and at least one of the plurality of external resources, the interface configured to mediate access through the plurality of capabilities; and generate logging data associated with execution of the pipeline.

In some aspects, the instructions, when executed by the at least one processing resource, may further cause the at least one processing resource to: receive user-defined logic through an interface associated with an evaluation environment; generate, based on the user-defined logic, a compiled representation configured for execution in the sandbox environment; transmit, to the pipeline, the compiled representation for execution in the pipeline; determine a capability configured to provide access to a large language model; and limit, through the capability, at least one of a number of calls and an amount of input data associated with access to the large language model during execution of the pipeline.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram illustrating a layered security testing and AI evaluation system, according to an embodiment;

FIG. 2 is a schematic diagram illustrating a sandbox environment communicating with capabilities through a defined call interface to access external resources, according to an embodiment;

FIG. 3 is a flow chart illustrating a method for layered security testing and AI evaluation, according to an embodiment;

FIG. 4A illustrates an example command-line invocation for executing a layer associated with an email capability, illustrated as a command-line interface format;

FIG. 4B illustrates an example response data structure returned from execution of a capability through the executor, illustrated as a text-based protocol response format;

FIG. 4C illustrates an example pipeline definition linking layers and capabilities, illustrated as a YAML configuration format;

FIG. 4D illustrates an example pipeline definition for local execution of a capability associated with a stolen model, illustrated as a YAML configuration format;

FIG. 4E illustrates an example pipeline definition for remote execution of a capability through a host specification, illustrated as a YAML configuration format;

FIG. 4F illustrates an example layer implementation configured to iteratively modify input data and invoke a pipeline through a pipeline call interface, illustrated as a source-code format;

FIG. 4G illustrates an example layer implementation for evaluation of model output using a capability configured to provide access to an auxiliary large language model, illustrated as a source-code format; and

FIG. 4H illustrates an example capability interface definition for a large language model capability, illustrated as a source-code interface definition format.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

This disclosure relates to techniques for security testing and Artificial Intelligence (AI) evaluation using a layered architecture that separates user-defined logic from system resource access. Security testing platforms can provide extensible environments for evaluating the robustness of software systems and AI models against adversarial inputs and attack scenarios. Such platforms can provide users a platform to dynamically load and chain independent components, creating customized sequences of operations targeted at particular systems under evaluation. For example, a penetration testing platform can provide a user a platform to combine a network interaction component with a data processing component to form a multi-stage attack chain. Sandboxing approaches can further support community contribution of such components by isolating loaded code in memory with restricted access to the surrounding execution environment.

Conventional modular testing platforms couple user-defined logic directly with the execution components that perform operations on external resources. The coupling of testing logic and system resource access in a single execution environment creates challenges in allowing third-party or user-submitted code to execute without restriction. Without a defined boundary between user logic and system resource access, user-authored code can call remote services, access hardware, and interact with external systems without constraint. The absence of such a boundary also presents challenges in reusing components across different testing scenarios, and in supporting open evaluation environments where untrusted contributors can participate without exposing underlying system resources to unrestricted direct access through the user-defined layer logic. Furthermore, conventional approaches do not provide a mechanism by which resource access restrictions can be embedded in a system component that can be not editable by the user authoring the associated logic.

The techniques described herein can address the above challenges by separating user-defined logic from system resource access through a layered architecture in which an executor can orchestrate execution of distinct layer components and capability components. Layer components can contain user-defined logic and can execute in a sandbox environment that restricts direct access to external resources. Capability components can provide access to external resources through defined call interfaces, such that layer components can influence external systems only through limited and controlled connections. The techniques described herein can place access restriction logic within capability components rather than within user-editable layer components, such that restrictions on resource access are not subject to modification by the user authoring the layer logic.

In some implementations, an executor can be instantiated to orchestrate a set of layer components and capability components. The executor can load layer components from repositories, verify binary signature data associated with the loaded components, and authorize execution based on the signature data. The executor can generate a pipeline that links one or more layer components with one or more capability components according to configuration data, where the configuration data can specify input mappings, output mappings, and transport data for each stage of the pipeline. Layer components can call capability components through remote procedure calls, and the serialized data exchanged in such calls can be communicated according to a transport specified in the configuration data. The same pipeline definition can be executed in a command-line interface environment or in a server environment without changing the underlying architecture, and a capability component in the pipeline can be switched between local execution and remote execution through a single change to the configuration data.

The techniques described herein can address the challenges of conventional modular testing platforms by providing a defined boundary between user-defined logic and system resource access. By placing access restriction logic within capability components rather than within layer components, the techniques described herein can support open evaluation environments in which user-submitted code executes within a sandbox environment without exposing the surrounding system to unconstrained resource access. The separation of layer and capability components also supports reuse of pipeline definitions across varied execution environments and testing scenarios, providing a technical improvement over conventional approaches where testing logic and resource access can be tightly coupled in a single execution context.

In some implementations, the layered architecture described herein can be used for evaluation of security properties of an Artificial Intelligence (AI) agent, including a large language model (LLM) agent. In such implementations, logic implementing an agent evaluation routine executes as one or more layers in the sandbox environment, and external interactions available to the agent evaluation routine can be limited to operations exposed by capability components through a defined call interface. The executor can orchestrate execution of the agent evaluation routine, route capability calls through the defined call interface, and generate logging data associated with execution of the pipeline to support auditability and analysis of agent behavior. In some implementations, the layered architecture can support evaluation-oriented or task-oriented execution associated with an AI agent, including an LLM agent, while maintaining the separation between layer logic and capability-mediated resource access. In such implementations, logic associated with the AI agent can execute as one or more layers in the sandbox environment, and interactions with external resources can occur through one or more capabilities exposed by a defined call interface. The executor can orchestrate execution of the layers, route capability calls, and generate logging data associated with execution of the pipeline to support auditing and analysis of agent-related behavior.

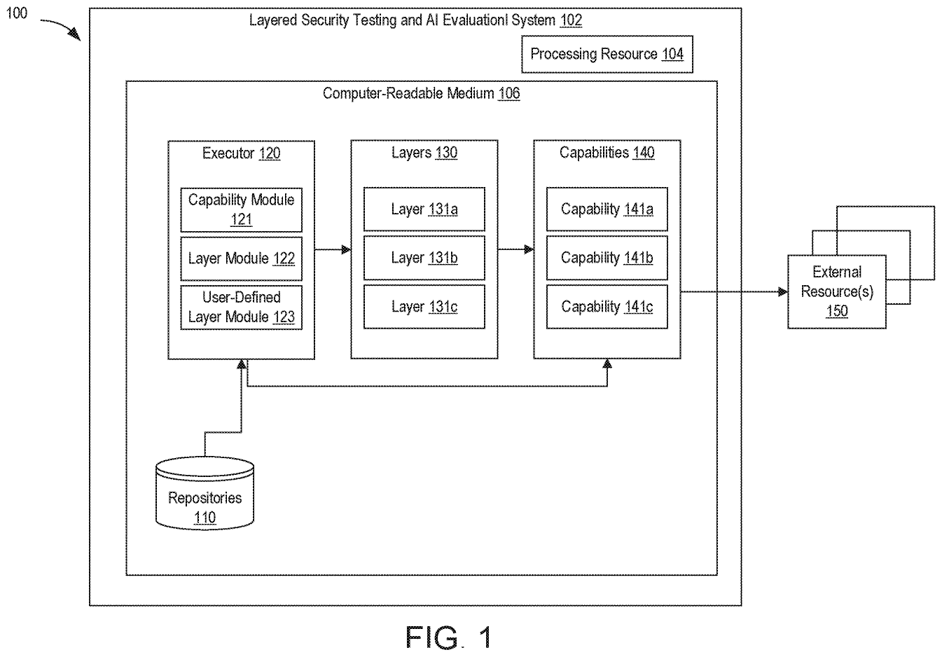

Referring now to FIG. 1, illustrated is a block diagram of an example system 100 for layered security testing and Artificial Intelligence (AI) evaluation, in accordance with one or more implementations. The system 100 can include a layered security testing and AI evaluation system 102. The layered security testing and AI evaluation system 102 can include a processing resource 104 and a computer-readable medium 106. The computer-readable medium 106 can include an executor 120, one or more layers 130, and one or more capabilities 140. The executor 120 can include a capability module 121, a layer module 122, and a user-defined layer module 123. The one or more layers 130 can include one or more layers 131a-131c. The one or more capabilities 140 can include one or more capabilities 141a-141c. The system 100 can further include one or more repositories 110 and one or more external resource(s) 150.

The layered security testing and AI evaluation system 102 can be a computer-implemented platform that separates user-defined logic from system resource access through a layered architecture in which distinct executor 120, layers 130, and capabilities 140 components operate under coordinated orchestration. In some implementations, the layered security testing and AI evaluation system 102 can take the form of a server-hosted platform, a locally deployed tool, or an open evaluation environment that receives and executes user-submitted logic in a sandboxed context without exposing underlying system resources to unrestricted direct access through the user-defined layer logic. For example, the layered security testing and AI evaluation system 102 can receive user-submitted Rust-language evaluation code through a web interface, compile that code to a WebAssembly binary, and load the binary into a pre-configured pipeline that couples the sandboxed layer to a capability whose access restrictions can be not editable within the submitted code. In some implementations, the layered security testing and AI evaluation system 102 can be configured as an evaluation environment for an LLM agent, where agent evaluation logic can be provided as user-defined logic and executed as a sandboxed layer. For example, a layer can define an evaluation function configured to receive LLM agent output or model output as input and generate an evaluation score. The evaluation function can call a capability configured to provide access to an auxiliary large language model for analysis of the output through the defined call interface. In some implementations, the capability enforces restrictions on access to the auxiliary large language model comprising limiting the evaluation function to a single call and limiting input length to fewer than 2000 characters during execution of the pipeline.

The layered security testing and AI evaluation system 102 can generate or receive a compiled representation of user-defined logic for execution in the sandbox environment, such as a WebAssembly representation or another executable representation suitable for an execution environment. The layered security testing and AI evaluation system 102 can instantiate the executor 120 to orchestrate execution of one or more layers 130 and one or more capabilities 140, and can generate a pipeline linking at least one of the one or more layers 130 with at least one of the one or more capabilities 140 according to configuration data defining input mappings, output mappings, and transport data. In some implementations, the layered security testing and AI evaluation system 102 can receive a YAML-formatted pipeline definition specifying source locations for the one or more layers 130 and the one or more capabilities 140, input and output mappings for each stage, and execution parameters such as rate limiting, and can execute the defined pipeline over an input dataset to generate processed output data. For example, the layered security testing and AI evaluation system 102 can read a two-stage YAML payload that maps dataset columns such as from, subject, and body to an email layer input, routes the returned protocol response data to an intermediate named value, and maps that intermediate value to the input of a feature-extraction layer to generate a numeric vector output file.

The layered security testing and AI evaluation system 102 can generate an interface between the one or more layers 130 and one or more external resource(s) 150, where the interface mediates access through the one or more capabilities 140. In some implementations, the layered security testing and AI evaluation system 102 can expose a typed remote procedure call trait as the complete set of operations available to the one or more layers 130, such that any access path from the one or more layers 130 to the one or more external resource(s) 150 that falls outside that typed interface can be blocked by the sandbox environment. For example, the layered security testing and AI evaluation system 102 can expose an email sending function and a model scoring function as the bounded set of operations reachable by the one or more layers 130, preventing those layers from issuing direct calls to network, file, or hardware resources outside those typed interfaces.

The layered security testing and AI evaluation system 102 can include a processing resource 104. The processing resource 104 can be one or more processors, microprocessors, or processing units that execute instructions stored on the computer-readable medium 106 to carry out the operations of the layered security testing and AI evaluation system 102. In some implementations, the processing resource 104 can include one or more central processing units, graphics processing units, or other hardware processing elements that execute binary-verified layer and capability code loaded by the executor 120. For example, the processing resource 104 can execute compiled WebAssembly code associated with one or more layers 131a-131c within a sandboxed runtime environment to restrict that code from directly accessing the one or more external resource(s) 150. The processing resource 104 can execute instructions that cause the layered security testing and AI evaluation system 102 to instantiate the executor 120, load the one or more layers 130 and one or more capabilities 140, generate pipelines, and transmit calls between components. The processing resource 104 can couple with the computer-readable medium 106 to retrieve and execute stored instructions that implement the layered architecture described herein. In some implementations, the processing resource 104 can retrieve executor orchestration instructions from the computer-readable medium 106 and execute those instructions to load capability and layer code from the one or more repositories 110 and authorize execution based on binary signature data associated with the retrieved code.

The layered security testing and AI evaluation system 102 can include a computer-readable medium 106. The computer-readable medium 106 can be a non-transitory storage medium, such as flash memory, a solid-state drive, or a magnetic disk, among others, that stores instructions executable by the processing resource 104 to implement the layered security testing and AI evaluation architecture. In some implementations, the computer-readable medium 106 can store compiled WebAssembly representations of one or more layers 131a-131c as well as native or WebAssembly capability code for one or more capabilities 141a-141c that can be dynamically loaded by the executor 120 during pipeline execution. The computer-readable medium 106 can store instructions that, when executed by the processing resource 104, cause the layered security testing and AI evaluation system 102 to instantiate the executor 120, determine the one or more layers 130 and the one or more capabilities 140, generate a pipeline, transmit calls via the pipeline, generate an interface, and generate logging data. In some implementations, the computer-readable medium 106 can store a pipeline executor library that can be built into other tools so that the same configuration files can be executed in a command-line interface environment or on a server in response to triggered events or on a schedule, without changing the underlying architecture. For example, the computer-readable medium 106 can store a library binary that the processing resource 104 loads into a server-side process, that process can then execute a YAML-formatted pipeline definition over data retrieved from a storage mechanism in response to a scheduled trigger, using the same executor 120 orchestration logic as a command-line invocation of the same pipeline definition.

The computer-readable medium 106 can be accessed by the processing resource 104 to retrieve stored instructions and data associated with the executor 120, one or more layers 130, and one or more capabilities 140 during execution. In some implementations, the computer-readable medium 106 can store YAML-formatted configuration data specifying layers to be executed, capabilities to be loaded, input and output mappings, rate limiting and other execution parameters, and source locations for layers and capabilities retrieved from the one or more repositories 110. For example, the computer-readable medium 106 can store a two-stage YAML payload definition that identifies a repository-hosted WebAssembly email layer and a locally compiled extraction layer, specifies input mappings that associate dataset columns such as from, subject, and body with layer function inputs, specifies output mappings that route intermediate response data between stages, and declares source location fields that the executor 120 resolves to retrieve the corresponding layer and capability binaries from the one or more repositories 110 prior to pipeline execution.

The computer-readable medium 106 can include an executor 120. The executor 120 can be an orchestration component that schedules, coordinates, and executes plugins by loading layer and capability code, verifying component integrity, establishing communication channels, and mediating the flow of data between the one or more layers 130 and the one or more capabilities 140. In some implementations, the executor 120 can function as a pipeline engine that receives a YAML payload definition, loads the specified layers and capabilities from the one or more repositories 110 or local paths, verifies binary signatures, maps inputs and outputs across stages, and executes the resulting pipeline over an input dataset. For example, the executor 120 can receive a two-stage YAML payload that identifies a repository-hosted email layer and a locally compiled extraction layer, resolve the source location fields for both the layer and capability binaries, verify those binaries, and execute the resulting pipeline over a dataset file to generate a processed output file. The executor 120 can orchestrate execution of the one or more layers 130 and the one or more capabilities 140 and can enforce at least one execution control, such as rate limiting or load balancing, on calls directed to one or more capabilities 141a-141c.

In some implementations, the executor 120 can retrieve at least one of the one or more layers 130 and at least one of the one or more capabilities 140 from the one or more repositories 110, determine binary signature data associated with those components, and authorize execution based on the binary signature data. For example, the executor 120 can load a layer module 122 or capability module 121 from a remote repository endpoint, verify the cryptographic signature of the retrieved binary, and, upon successful verification, load the binary into the execution environment before establishing communication channels between layers 131a-131c and capabilities 141a-141c. In some implementations, the executor 120 can handle input and output mapping between the one or more layers 130 and the one or more capabilities 140 by reading input mappings and output mappings declared in the pipeline configuration data and routing data values between components at each stage boundary. For example, the executor 120 can read an input_mapping field associating dataset columns such as from, subject, and body with layer function inputs, and an output_mapping field routing the returned response data to a named intermediate value consumed by a downstream layer, before invoking each stage in the pipeline.

The executor 120 can include a capability module 121. The capability module 121 can be a loadable code unit that the executor 120 uses to instantiate and communicate with a corresponding capability from the one or more capabilities 140, providing the executor 120 with the interface definitions and transport bindings needed to direct calls from the one or more layers 130 to the appropriate capability implementation. In some implementations, the capability module 121 can contain a compiled representation of a remote procedure call trait definition, such as an email capability interface, that the executor 120 loads to establish a typed communication channel between a layer and the underlying capability that sends emails and returns response data. The capability module 121 can be used by the executor 120 to identify a first capability for local execution by dynamic loading or a second capability for remote execution through a communication channel, and to select between those options according to transport data in the pipeline configuration. In some implementations, the capability module 121 can encode a source field specifying a local repository path for local dynamic loading, or a host field specifying a remote server endpoint for remote execution. For example, the capability module 121 can encode a source field that the executor 120 resolves to a local repository path when the capability can be dynamically loaded into the local execution environment, or a host field that the executor 120 resolves to a remote server endpoint when the capability can be executed remotely, the executor 120 can route calls to one or more capabilities 141a-141c without modifying the layer binary or any input mapping, output mapping, or other pipeline definition data.

The executor 120 can include a layer module 122. The layer module 122 can be a loadable code unit, such as a compiled WebAssembly binary or a natively compiled binary, that the executor 120 retrieves from the one or more repositories 110 and uses to instantiate one or more of the layers 131a-131c within the execution environment. In some implementations, the layer module 122 can correspond to a default email layer stored at a remote repository endpoint, which the executor 120 retrieves and loads as a sandboxed WebAssembly binary to execute user-defined logic that processes input fields and produces output data for downstream pipeline stages. The layer module 122 can be used by the executor 120 to identify user-defined logic written in at least one programming language, generate a compiled representation for execution in the sandbox environment, the compiled representation comprising, for example, a WebAssembly representation or another executable representation, and transmit the compiled representation to the pipeline for execution. In some implementations, the compiled representation executed by the executor 120 can correspond to logic that is provided or generated for a selected evaluation objective, including an agent evaluation objective, a prompt, or a task specification, and prepared for execution in the sandbox environment in the same manner as other user-defined logic. For example, logic associated with an AI agent or an LLM agent can be generated or otherwise obtained in a supported programming language, compiled into a WebAssembly representation or another executable representation suitable for an execution environment, and loaded as one of the layers in a pipeline. In such implementations, the compiled representation remains subject to the same capability-mediated access restrictions applied to other layers.

In some implementations, the layer module 122 can store a Rust-language layer function annotated with an interface macro that the executor 120 compiles to a WebAssembly binary, the function can then be called within an attack chain pipeline while remaining isolated from direct access to the one or more external resource(s) 150. For example, the layer module 122 can store a layer function that accepts a message body string as input and returns a vector of floating point values, where the interface macro wires the function signature into the executor 120's orchestration pathway such that the function receives a main call from the executor 120 and transmits calls to one or more of the capabilities 141a-141c through a defined call interface rather than through any direct path to the one or more external resource(s) 150.

The executor 120 can retrieve the layer module 122 from the one or more repositories 110 by resolving a source location field from pipeline configuration data to a repository URL or local path, retrieve the corresponding binary artifact, and load the verified binary into the sandboxed execution environment before linking it to the appropriate capability through a defined call interface. For example, the executor 120 can resolve a layer source URL from an email stage declared in a YAML payload definition, retrieve the compiled WebAssembly email layer binary from the one or more repositories 110, and then instantiate the corresponding one of the layers 131a-131c in the sandboxed runtime before coupling it to one of the capabilities 141a-141c through the defined call interface for pipeline execution.

The executor 120 can include a user-defined layer module 123. The user-defined layer module 123 can be a loadable code unit authored by a contributor, penetration tester, or evaluation participant, which the executor 120 receives, compiles to a sandboxed execution format such as WebAssembly, and loads into the pipeline alongside repository-sourced layer and capability components. In some implementations, the user-defined layer module 123 can be a Rust-language function submitted through a web interface that can be compiled to WebAssembly upon submission, loaded into a pre-configured pipeline, and executed against a capability whose access restrictions can be embedded in the capability and can be not editable within the submitted code. The executor 120 can receive user-defined logic through an interface associated with an evaluation environment, generate a compiled representation for execution in the sandbox environment, and transmit the compiled representation to the pipeline for execution.

In some implementations, the user-defined logic comprises logic for evaluating behavior of an AI agent, including an LLM agent, and the user-defined logic executes as untrusted code in the sandbox environment. For example, the user-defined logic can implement an evaluation routine configured to score agent output against a target condition, and the evaluation routine can call one or more capabilities through the defined call interface to obtain auxiliary processing. In some implementations, the auxiliary processing comprises analysis performed by an auxiliary large language model accessed through a capability, and restrictions on access to the auxiliary large language model can be enforced by the capability implementation rather than by the user-defined logic. The executor 120 can generate logging data and debugging data associated with execution of the user-defined logic to support auditing and reproducibility of agent evaluation results.

In some implementations, the user-defined layer module 123 can receive a user-submitted evaluation function that calls an auxiliary large language model capability at most once per execution and with no more than a defined character limit per request, where those restrictions reside in the capability implementation rather than in the user-defined layer module 123 itself. For example, when a user submits evaluation code through a web interface, the executor 120 can compile that code into a WebAssembly binary, load the binary into a pre-configured pipeline, and couple the user-defined layer module 123 to a capability that limits invocations to a single call with fewer than 2000 characters of input per pipeline execution, with those restrictions not accessible or modifiable through the user-defined layer module 123. The executor 120 can load the user-defined layer module 123 into the sandbox environment and enforce security boundaries between the user-authored code and the one or more external resource(s) 150 through the defined call interface of the one or more capabilities 140. In some implementations, the executor 120 can instantiate the user-defined layer module 123 within a WebAssembly runtime that prevents the code from issuing direct calls to network, file, or hardware resources, routing all external interactions through one or more of the capabilities 141a, 141b, or 141c via defined remote procedure call interfaces.

The computer-readable medium 106 can include one or more layers 130. The one or more layers 130 can be a set of execution units, each containing user-defined logic that executes in a sandbox environment, communicates with one or more capabilities 140 through well-defined interfaces, processes input data, and generates output data according to pipeline configuration. In some implementations, the one or more layers 130 can contain user-defined logic defining at least one of security test logic and AI evaluation logic, where one or more layers 131a-131c can be chained together to form multi-stage processing pipelines in which the output of each layer can be mapped to the input of the next stage according to the input mappings and output mappings declared in the configuration data. For example, the one or more layers 130 can include a default email layer that accepts from, subject, and body inputs and generates protocol response data, and a custom feature-extraction layer that accepts that response data and generates an array of floating point values, linked in sequence by the executor 120 so that the numeric output of the extraction layer can be available as input to downstream pipeline stages. The one or more layers 130 can communicate with one or more capabilities 140 through remote procedure calls transmitted by the executor 120, and can receive configuration data through a key-value map. In some implementations, one or more layers 131a-131c can each issue an asynchronous remote procedure call to a corresponding one of the one or more capabilities 140, receive serialized response data, and pass that data as input to the next layer in the pipeline, with serialization performed according to a format such as JSON, rkyv, Flatbuffers, or msgpack, among others, as specified in the transport data.

In some implementations, one or more of the layers 130 comprise agent evaluation logic configured to process LLM agent output or intermediate model output and to produce evaluation results. The agent evaluation logic can call one or more capabilities through the defined call interface to obtain auxiliary computation used to compute an evaluation score. In such implementations, the sandbox environment restricts access by the agent evaluation logic to external resources outside the defined call interface.

The layers 130 can include one or more layers 131a-131c. One or more layers 131a-131c can each be an individual execution unit that the executor 120 loads from a repository or local path, instantiates in a sandboxed runtime environment, and calls as a stage in the pipeline. In some implementations, each of the one or more layers 131a-131c can execute as a WebAssembly binary, or, in lower security environments, as a natively compiled binary loaded from the one or more repositories 110. For example, layer 131a can correspond to a repository-hosted email layer compiled to WebAssembly that accepts message input fields and generates protocol response data, layer 131b can correspond to a locally authored feature-extraction layer compiled to WebAssembly that accepts protocol response data and generates an array of floating point values, and layer 131c can correspond to an attack-phase layer that iteratively calls a named sub-pipeline through a pipeline call interface to generate an evasion result. In some implementations, one of the one or more layers 131a-131c can invoke a second pipeline through a pipeline call interface to obtain an intermediate result used in an evaluation routine. The second pipeline can be named in pipeline configuration data and can be resolved by the executor 120 in response to a call from the layer. In such implementations, the layer can obtain auxiliary computation through the second pipeline while remaining confined to the sandbox environment and while external resource access remains mediated through the one or more capabilities 140.

One or more layers 131a-131c can each process input data and generate output according to pipeline configuration, and can be linked in a processing sequence by the executor 120 according to the input mappings and output mappings defined in the configuration data. For example, the executor 120 can map an output of layer 131a to an input of one of the capabilities 140, map the output of that capability to an input of layer 131b, and link those components in a processing sequence that transforms message inputs into numeric vector outputs suitable for downstream machine-learning processing.

One or more layers 131a-131c can each execute in the sandbox environment enforced by the executor 120, receiving input through main calls from the executor 120 and transmitting calls to the capabilities 140 through remote procedure calls. In some implementations, one or more layers 131a-131c can each receive configuration data through a key-value map, with the executor 120 supplying the key-value map to the layer at the time of invocation so that execution parameters such as iteration limits can be accessible within the sandboxed runtime environment. For example, layer 131c can execute a bounded loop that repeatedly calls a named sub-pipeline through a pipeline call interface, evaluates returned floating point scores against a target condition, and returns a modified message body upon satisfaction of that condition or returns no result upon exhausting a configured iteration limit loaded from the key-value map.

The computer-readable medium 106 can include one or more capabilities 140. The one or more capabilities 140 can be executable code units that provide controlled access to one or more external resource(s) 150, run as native code or WebAssembly, and expose well-defined call interfaces to the one or more layers 130, where access restriction logic can be embedded in the capability and can be not editable by the author of the corresponding layer. In some implementations, the one or more capabilities 140 can include an email capability that sends messages through an SMTP interface and returns protocol response data, a model-scoring capability that receives text input and returns an array of floating point scores, or a large language model capability that receives a string and returns a generated string subject to server-side call count and input size restrictions. For example, a capability among one or more capabilities 141a-141c can provide an interface to specialized hardware such as a GPU, a software-defined radio, or a particular vulnerability implementation, receiving calls from one or more layers 130 through a typed remote procedure call interface and performing resource allocation and access control before forwarding those calls to the corresponding one or more external resource(s) 150.

The one or more capabilities 140 can provide executable code for controlled access to at least one of the one or more external resource(s) 150, provide well-defined call interfaces for the one or more layers 130 to consume, and perform resource access control and security checks on calls received from the one or more layers 130. The one or more capabilities 140 can be loaded locally by the executor 120 through dynamic loading when executed locally, or can be executed remotely through a communication channel to a remote server or a remote executor, with the selection between local and remote execution determined by transport data in the configuration. In some implementations, a capability among one or more capabilities 141a-141c can initially be loaded locally from a repository source path and, upon encountering rate-limiting constraints imposed by the target system, can be redeployed as a remote capability served from a distributed infrastructure endpoint, with the transition effected by changing a single source field to a host field in the pipeline configuration without modifying any layer or mapping definitions.

In some implementations, one of the capabilities 140 comprises a capability configured to provide access to an auxiliary large language model used in an agent evaluation routine. The capability can enforce restrictions on calls from a layer to the auxiliary large language model, including restricting the number of calls permitted during execution of the pipeline and restricting input size. In some implementations, the capability restricts the number of calls to a single call and restricts input size to fewer than 2000 characters during execution of the pipeline, thereby limiting abuse in an evaluation environment executing user-defined logic.

In some implementations, one or more capabilities accessible to agent-related logic can provide controlled access to one or more external resources comprising a network resource, a file resource, a model service, a hardware resource, or a second pipeline. The executor 120 can route calls from agent-related logic to the one or more capabilities through the defined call interface, such that the agent-related logic obtains external data or auxiliary computation without direct access to the corresponding external resources.

The one or more capabilities 140 can include one or more capabilities 141a-141c. One or more capabilities 141a-141c can each be an individual capability implementation that the executor 120 loads from a local or remote source and makes available to one or more layers 131a-131c through a defined remote procedure call interface, where each capability can run as native code or as a WebAssembly binary. In some implementations, one or more capabilities 141a-141c can each expose a typed remote procedure call trait, such as an email sending function, a model scoring function, or a large language model generation function, among others, and the executor 120 can enforce that layer code in the sandbox environment can reach the one or more external resource(s) 150 through those typed interfaces, with no direct resource access path available to the layer code. For example, capability 141a can correspond to an email capability that transmits messages to a target server and returns protocol response data, capability 141b can correspond to a model-scoring capability that receives text input and returns a vector of floating point scores, and capability 141c can correspond to a large language model capability whose server-side implementation limits callers to a single invocation with fewer than a threshold number of input characters per pipeline execution. One or more capabilities 141a-141c can each transmit a defined call interface to the one or more layers 130, provide access to at least one of the one or more external resource(s) 150 based on the defined call interface, and prevent access by the one or more layers 130 to the one or more external resource(s) 150 outside the defined call interface.

One or more capabilities 141a-141c can each be loaded dynamically by the executor 120 when executed locally, or can be permanently installed or loaded by a remote executor when executed remotely, and can be reused across different pipeline configurations without modification. In some implementations, one or more capabilities 141a-141c can be authored using a capability software development kit in Python, served from a remote endpoint, and referenced by multiple distinct pipeline configurations that each specify a different set of one or more layers 130 and input-output mappings. For example, a Python-authored email capability served at a remote botnet endpoint can be referenced by a dataset-scale extraction pipeline and an attack-phase evasion pipeline, each supplying different layers 130 and input-output mappings while invoking the same capability implementation without modification.

The system 100 can include one or more repositories 110. The one or more repositories 110 can be remote or local storage systems that store compiled layer binaries, capability binaries, and associated metadata, from which the executor 120 retrieves components by resolving source location references specified in pipeline configuration data. In some implementations, the one or more repositories 110 can include a public repository of default layer implementations and capability implementations, as well as private or local paths storing user-authored layer binaries, from which the executor 120 retrieves and verifies components before instantiating them in the execution environment. For example, the one or more repositories 110 can serve a default email layer WebAssembly binary and an email capability binary to the executor 120 in response to URL-based retrieval requests derived from source location fields in a YAML configuration file. The one or more repositories 110 can provide the executor 120 with at least one of the one or more layers 130 and at least one of the one or more capabilities 140 for loading and authorized execution. The one or more repositories 110 can be accessed by the executor 120 during pipeline instantiation by resolving source location data from the pipeline configuration and retrieving the corresponding binary artifacts over a network or local file path. For example, the executor 120 can resolve a layer source URL from the pipeline configuration, retrieve the compiled WebAssembly binary from the one or more repositories 110, and then load the verified binary as one or more layers 131a-131c within the sandboxed execution environment.

The system 100 can include one or more external resource(s) 150. The one or more external resource(s) 150 can be system resources, network services, hardware devices, external platforms, or software interfaces that the one or more capabilities 140 access on behalf of the one or more layers 130, where the one or more layers 130 can reach the one or more external resource(s) 150 through the defined call interfaces provided by the one or more capabilities 140 and not through any direct access path. In some implementations, the one or more external resource(s) 150 can include an SMTP email server targeted by a model-stealing attack chain, a large language model API accessed by an evaluation pipeline, a GPU used for hardware-accelerated inference, or a software-defined radio interface accessed through a specialized capability, among others. For example, a capability among the one or more capabilities 140 can transmit an SMTP message to one or more external resource(s) 150 and return protocol response data to the calling layer, with the capability enforcing any applicable rate limits or call restrictions before forwarding the request to the one or more external resource(s) 150. The one or more external resource(s) 150 can be accessed by the one or more capabilities 140 in response to calls received from the one or more layers 130 through the defined call interface, with access restricted to the operations and parameters permitted by that interface. In some implementations, the one or more external resource(s) 150 can be reached by the one or more capabilities 140 through transport channels specified in pipeline configuration data, such as HTTP connections to remote servers, native system interfaces, or WebAssembly-mediated channels, among others. For example, the one or more external resource(s) 150 can be reached through HTTP transport when a capability among the one or more capabilities 140 is executed remotely on a distributed infrastructure server, or through a native channel when that capability is dynamically loaded and executed locally by the executor 120.

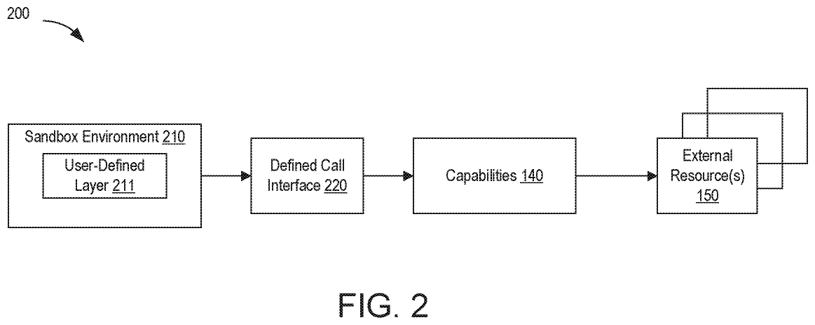

Referring now to FIG. 2, illustrated is a schematic diagram of a flow 200 illustrating a sandbox environment 210 communicating with capabilities through a defined call interface to access external resources, in accordance with one or more implementations. The flow 200 can include a sandbox environment 210 and a defined call interface 220. The sandbox environment 210 can include a user-defined layer 211. The flow 200 can further include one or more capabilities 140 and one or more external resources 150.

The flow 200 can include a sandbox environment 210. The sandbox environment 210 can be an isolated execution context in which user-defined logic executes with restricted access to system resources, memory isolation, and tightly controlled pathways to external systems, such that code executing within the sandbox environment 210 can be configured not to directly reach the external resource(s) 150 outside of the defined call interface 220. In some implementations, the sandbox environment 210 can be implemented as a WebAssembly runtime that constrains the execution of a user-defined layer 211 to a sandboxed memory space, the sandboxed memory space can prevent the user-defined layer 211 from issuing system calls or directly accessing network, file, or hardware resources outside of the runtime's controlled boundaries. For example, when a user-defined layer 211 performing an attack-phase evasion operation calls a pipeline iteratively to obtain model scores, the sandbox environment 210 can route each such call through the defined call interface 220 rather than permitting the user-defined layer 211 to directly contact any external service. The sandbox environment 210 can execute the user-defined layer 211 and mediate all outbound interactions from the user-defined layer 211 through the defined call interface 220, such that the user-defined layer 211 can influence the external resource(s) 150 through limited and controlled connections. The sandbox environment 210 can enforce its isolation by coupling with the defined call interface 220, through which the user-defined layer 211 transmits calls to the capabilities 140, and by blocking any access path from the user-defined layer 211 to the external resource(s) 150 that does not pass through the defined call interface 220.

In some implementations, the sandbox environment 210 can permit a user-submitted evaluation layer to call an auxiliary large language model capability through the defined call interface 220 subject to server-side call count and input size restrictions embedded in the capability, while the sandbox environment 210 can prevent the same layer from issuing any unrestricted outbound network connection. For example, when a user-defined layer 211 can be submitted through a web interface as part of an open evaluation environment, the sandbox environment 210 can receive the compiled WebAssembly binary for that user-defined layer 211 and couple it to a pre-configured pipeline that exposes the capabilities 140 through the defined call interface 220, with access restrictions embedded in the capability and not editable within the user-defined layer 211.

The sandbox environment 210 can include a user-defined layer 211. The user-defined layer 211 can be an execution unit containing logic authored by a contributor, penetration tester, or evaluation participant, written in a supported programming language such as Rust or Python, and compiled to a sandboxed execution format such as WebAssembly, which the executor 120 loads into the sandbox environment 210 and calls as a stage in a pipeline. In some implementations, the user-defined layer 211 can be a Rust function annotated with an interface macro that parses a protocol response string into an array of floating point values, or an evaluation function that receives model output and a target string, invokes an auxiliary large language model capability through the defined call interface 220, and returns a floating point score indicating evaluation success. For example, a user-defined layer 211 performing a feature-extraction operation can accept a text-based RCPT response string as input, parse using parsing logic to extract semicolon-delimited score fields from the response, and return those fields as an array of floating point values that a downstream pipeline stage can consume as numeric inputs to a machine-learning operation.

The user-defined layer 211 can transmit calls to the one or more capabilities 140 through the defined call interface 220, receive response data from the one or more capabilities 140, and generate output data for downstream pipeline stages according to configuration data specifying input mappings and output mappings. In some implementations, the user-defined layer 211 can issue an asynchronous remote procedure call to a model-scoring capability through the defined call interface 220, receive a returned vector of floating point scores, evaluate the scores against a target condition, and either return a modified message body or continue iterating up to a configured iteration limit loaded from a key-value map. For example, a user-defined layer 211 implementing an attack-phase evasion operation can instantiate a pipeline call client referencing a named sub-pipeline, call that sub-pipeline on successive versions of a message body within a bounded loop, and return the modified message body wrapped in an optional value upon satisfaction of a detection threshold, or return no result upon exhausting the configured limit. The user-defined layer 211 can execute within the sandbox environment 210 by receiving a main call from the executor 120 and then transmitting calls to the one or more capabilities 140 through the defined call interface 220, with serialization of exchanged data performed according to a format such as JSON, rkyv, Flatbuffers, or msgpack, among others, as specified in transport data.

In some implementations, when the user-defined layer 211 can be submitted through a web interface as part of an open evaluation environment, the executor 120 can compile the submitted code into a WebAssembly binary, load the binary into the sandbox environment 210, and couple the user-defined layer 211 to a pre-configured pipeline that exposes the one or more capabilities 140 through the defined call interface 220, with access restrictions embedded in the capability implementation and not editable within the user-defined layer 211. For example, when a user submits an evaluation function through a web interface that calls an auxiliary large language model capability, the executor 120 can compile that function to WebAssembly, load the resulting binary as the user-defined layer 211 in the sandbox environment 210, and route all calls from the user-defined layer 211 to the large language model service through a capability whose server-side implementation limits the caller to a single invocation with fewer than a threshold number of input characters per pipeline execution, with those restrictions not accessible or modifiable through the user-defined layer 211.

The flow 200 can include a defined call interface 220. The defined call interface 220 can be a typed boundary that specifies the permitted communications between a user-defined layer 211 executing in the sandbox environment 210 and the one or more capabilities 140, expressed as a set of typed function signatures or remote procedure call traits that constrain the operations the user-defined layer 211 can invoke on the one or more capabilities 140. In some implementations, the defined call interface 220 can be expressed using a protocol language and a Rust macro that declares a trait with an asynchronous scoring function accepting a body string and returning a vector of floating point values, from which interface code can be generated for both Python and Rust using a command-line tool, providing a typed communication channel between the sandbox environment 210 and the capability implementation. For example, the defined call interface 220 can expose an email sending function and a model scoring function as the complete set of operations accessible to the user-defined layer 211, such that any attempt by the user-defined layer 211 to access one or more external resource(s) 150 through a path not covered by those typed function signatures can be blocked by the sandbox environment 210.

The defined call interface 220 can provide the set of typed function signatures to the user-defined layer 211, provide access to at least one of the one or more external resource(s) 150 via the one or more capabilities 140 based on the typed function signatures, and can prevent access by the user-defined layer 211 to the one or more external resource(s) 150 outside those typed function signatures. The defined call interface 220 can route calls from the user-defined layer 211 to the one or more capabilities 140 according to transport data in the pipeline configuration data, including WebAssembly function calls, HTTP connections, or native channels, among others, and can serialize the data exchanged in those calls according to a selected serialization format such as JSON, rkyv, Flatbuffers, or msgpack, among others. In some implementations, the defined call interface 220 can define a bounded toolset available to an LLM agent evaluation routine executing as a layer, such that agent interactions with external resources can occur through a limited set of capability calls.

In some implementations, the defined call interface 220 can route a remote procedure call from the user-defined layer 211 to one of the one or more capabilities 140 served at a remote host endpoint over HTTP transport, serializing the call parameters and deserializing the returned scores according to a format such as msgpack, without requiring any modification to the user-defined layer 211 or the input mappings and output mappings declared in the pipeline configuration data. For example, when a user-defined layer 211 implementing an attack-phase evasion operation issues an asynchronous scoring call, the defined call interface 220 can serialize the message body input according to the selected serialization format, transmit the serialized payload to the remote capability endpoint over HTTP transport, receive the returned floating point score vector, and deserialize the response before forwarding it to the user-defined layer 211 for evaluation against a detection threshold, with the sandbox environment 210 blocking any direct outbound path from the user-defined layer 211 to the one or more external resource(s) 150 that falls outside the typed function signatures exposed by the defined call interface 220.

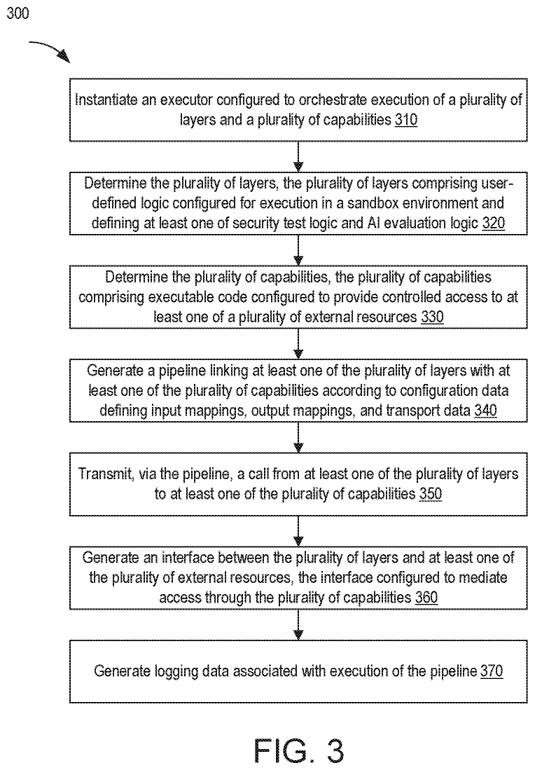

Referring now to FIG. 3, depicted is an illustrative flow diagram of a method 300 of layered security testing and Artificial Intelligence (AI) evaluation. The method 300 can be executed, performed, or otherwise carried out by any of the computing systems or devices described herein. In brief overview of the method 300, the method 300 can include instantiating an executor (step 310), determining the plurality of layers (step 320), determining the plurality of capabilities (step 330), generating a pipeline (step 340), transmitting a call via the pipeline (step 350), generating an interface (step 360), and generating logging data (step 370).

The method 300 can include instantiating an executor (step 310). The executor 120 can be instantiated by the layered security testing and AI evaluation system 102 as an orchestration component that schedules, coordinates, and executes plugins by loading layer and capability code, verifying component integrity, establishing communication channels, and mediating the flow of data between the layers 130 and the capabilities 140. In some implementations, the executor 120 can be instantiated as a pipeline engine that receives a YAML-formatted payload definition, loads the specified layers 130 and capabilities 140 from one or more repositories 110 or local paths, verifies binary signatures, and maps inputs and outputs across stages to prepare the resulting pipeline for execution over an input dataset. For example, the executor 120 can be instantiated in response to a command-line invocation specifying a payload file and an input dataset, resolving each layer and capability source location field from the payload definition before any layers 130 or capabilities 140 can be loaded into the execution environment. Step 310 can occur at the initiation of a pipeline execution, whether in a command-line interface environment, a server environment responding to triggered events, or an open evaluation environment receiving user-submitted logic. In some implementations, instantiating the executor 120 can comprise retrieving at least one of the layers 130 and at least one of the capabilities 140 from one or more repositories 110, determining binary signature data associated with those components, and authorizing execution based on the binary signature data. For example, upon instantiation, the executor 120 can retrieve a compiled WebAssembly layer binary from a remote repository URL specified in a YAML configuration file, verify the cryptographic signature of the retrieved binary, and load the verified binary into the execution environment before establishing communication channels between the layers 130 and the capabilities 140.

The method 300 can include determining the plurality of layers (step 320). The executor 120 can determine the layers 130 as execution units, each containing user-defined logic for execution in a sandbox environment and defining at least one of security test logic and AI evaluation logic, where each of the layers 130 processes input data and generates output data according to pipeline configuration. In some implementations, the layers 130 can include a default email layer that accepts message input fields and generates protocol response data, and a custom feature-extraction layer that accepts that response data and generates an array of floating point values representing model scores, chained together in a multi-stage attack chain pipeline. Step 320 can occur after step 310 and in response to the executor 120 parsing pipeline configuration data specifying source locations, input mappings, output mappings, and execution parameters for each layer stage.

In some implementations, when the executor 120 reads a YAML payload file identifying a repository-hosted email layer and a locally compiled extraction layer, the executor 120 can determine those layers 130 by resolving their source location fields and retrieving the corresponding binaries before instantiating them in the sandbox environment. The executor 120 can determine the layers 130 by identifying user-defined logic written in at least one programming language, generating a compiled representation for execution in the sandbox environment, the compiled representation comprising, for example, a WebAssembly representation or another executable representation, and transmitting the compiled representation to the pipeline for execution. In some implementations, determining the layers 130 comprises determining at least one layer configured for evaluation of an AI agent, including an LLM agent. For example, the executor 120 can determine a layer defining an evaluation function configured to receive agent output as input and generate an evaluation score. The executor 120 can execute the evaluation function in the sandbox environment and route calls from the evaluation function to one or more capabilities through the defined call interface. In some implementations, the compiled representation can comprise a WebAssembly representation, a native binary representation, or another executable representation suitable for an execution environment.

In some implementations, in lower-security environments, the executor 120 can load a natively compiled layer from one or more repositories 110 in place of a sandboxed representation for a given layer stage. In some implementations, determining the layers 130 can involve receiving a Rust-language evaluation function submitted through a web interface, compiling that function to a WebAssembly binary upon submission, loading the binary into a pre-configured pipeline, and coupling the resulting user-defined layer module 123 to a capability that enforces server-side access restrictions not editable within the layer code. For example, when a user submits an evaluation function through a web interface, the executor 120 can compile the submitted Rust-language code into a WebAssembly binary, load that binary as one of the layers 130 within the sandbox environment, and couple it to one of the capabilities 140 whose access restrictions can be embedded in the capability implementation and can be not accessible or modifiable through the submitted layer code.

The method 300 can include determining the plurality of capabilities (step 330). The executor 120 can determine the capabilities 140 as executable code units that provide controlled access to at least one of the external resource(s) 150, expose well-defined call interfaces to the layers 130, and embed access restriction logic that can be not editable by the author of the corresponding layer. In some implementations, the capabilities 140 can include an email capability that transmits messages through an SMTP interface and returns protocol response data, a model-scoring capability that receives text input and returns a floating point score vector, or a large language model (LLM) capability that receives a string and returns a generated string subject to server-side call count and input size restrictions, among others. For example, a capability among the capabilities 140 can receive a call from one of the layers 130 through a defined call interface, restrict using access restrictions embedded in the capability implementation, and forward the call to a corresponding one of the external resource(s) 150, returning response data to the calling layer without exposing any direct access path to that resource. Step 330 can occur after step 320 and in response to the executor 120 resolving capability source location fields or host fields from the pipeline configuration data.

In some implementations, when an email capability can be initially specified with a local source field, the executor 120 can determine and load that capability locally by dynamic loading; when rate-limiting constraints can be encountered, the pipeline configuration data can be updated to specify a remote host field so that the executor 120 determines and routes calls to that capability at a remote server endpoint without modifying any layer or mapping definitions. The executor 120 can determine the capabilities 140 by identifying a first capability for local execution by dynamic loading in the executor 120 and a second capability for remote execution through a communication channel to at least one of a remote server and a remote executor, and selecting between those options according to transport data in the pipeline configuration data. In some implementations, a capability authored using a capability software development kit in Python can be served from a remote endpoint and referenced by multiple distinct pipeline configurations, facilitating reuse of the capability implementation across varied attack chain scenarios without modification to the layers 130 or the pipeline configuration data. For example, a Python-authored email capability served at a remote endpoint can be referenced by a dataset-scale extraction pipeline and an attack-phase evasion pipeline, each supplying different layers 130 and input-output mappings while invoking the same capability implementation without modification.

The method 300 can include generating a pipeline (step 340). The executor 120 can generate the pipeline by linking at least one of the layers 130 with at least one of the capabilities 140 according to configuration data defining input mappings, output mappings, and transport data, such that each stage of the pipeline maps outputs from one component to inputs of the next component in the processing sequence. In some implementations, the executor 120 can generate the pipeline by reading a YAML-formatted payload definition that identifies a first stage specifying a repository-hosted email layer and a local capability source path, and a second stage specifying a locally compiled extraction layer, with input mappings that associate dataset fields such as from, subject, and body with the inputs of the email layer, an output mapping that routes the returned protocol response string to an intermediate named value, and a second input mapping that routes that intermediate named value to the input of the extraction layer. For example, the executor 120 can read a two-stage YAML payload identifying an email stage and an extract stage, instantiate the corresponding layers 130 and capabilities 140 in their respective execution contexts, map with the input mappings to bind dataset columns to layer function inputs, map with the output mappings to route intermediate values between stages, and execute the resulting pipeline over an input dataset file to generate a numeric vector output file. Step 340 can occur after step 330 and once the executor 120 has loaded and verified all layer and capability components referenced in the configuration data.

In some implementations, the executor 120 can generate the pipeline in response to a command-line invocation specifying a payload file and an input dataset, or in response to a triggered event in a server environment, with the same pipeline definition applied in either execution context. For example, the executor 120 can receive a command-line invocation specifying a YAML payload file and a dataset file as arguments, resolve the source location fields for each layer and capability declared in the payload, and link the resolved components according to the declared input and output mappings before beginning execution over the dataset. The executor 120 can generate the pipeline by identifying a first layer, a second layer, and a first capability from the configuration data, mapping an output of the first layer to an input of the first capability according to the input mappings, mapping an output of the first capability to an input of the second layer according to the output mappings, and linking those components in a processing sequence. In some implementations, the pipeline definition can be modified by replacing a capability source field with a host field to effect remote execution of that capability without altering any layer binary, input mapping, or output mapping declared in the pipeline definition. For example, when rate-limiting constraints prevent local execution of a capability over a large dataset, the executor 120 can read an updated YAML payload in which the capability source field of the email stage can be replaced by a host field pointing to a distributed infrastructure endpoint, establish a communication channel to that remote endpoint, and execute the pipeline over the dataset while leaving the email layer binary and all input and output mappings unchanged.

The method 300 can include transmitting a call via the pipeline (step 350). A call can be transmitted via the pipeline from at least one of the layers 130 to at least one of the capabilities 140, where the call can be routed through the defined call interface 220 and does not permit the at least one of the layers 130 to access the external resource(s) 150 outside that interface. In some implementations, a layer among the layers 130 performing an attack-phase evasion operation can transmit a remote procedure call to a model-scoring capability among the capabilities 140 through the pipeline, receive a returned vector of floating point scores, evaluate those scores against a target condition, and either return a modified message body or continue iterating up to a configured limit. For example, when the executor 120 invokes a layer among the layers 130 as a stage in the pipeline and the layer's logic determines that it can obtain data from at least one of the external resource(s) 150, the layer can transmit the call to the appropriate capability among the capabilities 140 at that point in the execution flow, with the sandbox environment 210 routing the call through the defined call interface 220. Step 350 can occur during execution of the pipeline after the pipeline has been generated in step 340 and at least one of the layers 130 has been invoked by the executor 120 through a main call. The call can be transmitted by generating a remote procedure call from at least one of the layers 130 to at least one of the capabilities 140, serializing data associated with the remote procedure call according to a serialization format such as JSON, rkyv, Flatbuffers, or msgpack, among others, and communicating the serialized data according to a transport specified by the transport data, such as WebAssembly function calls, HTTP connections, or native channels, among others.

In some implementations, when a Rust-language layer among the layers 130 calls a Python-implemented capability among the capabilities 140 through a generated typed interface, the call parameters can be serialized in a selected format, transmitted over HTTP transport to the remote capability server, and deserialized by the capability implementation, after which the returned result can be serialized and communicated back to the calling layer for further processing in the pipeline. For example, a Rust-language layer among the layers 130 can invoke a scoring function on a Python-implemented capability among the capabilities 140 by serializing the message body input according to the selected serialization format, transmitting the serialized payload over HTTP transport to the remote endpoint, and receiving a deserialized floating point score vector that the layer evaluates against a detection threshold before determining whether to return a modified message body or advance to the next iteration.

The method 300 can include generating an interface (step 360). The executor 120 can generate the interface between the layers 130 and at least one of the external resource(s) 150, where the interface mediates access through the capabilities 140 such that the layers 130 can influence the external resource(s) 150 through limited and controlled connections. In some implementations, the interface can be expressed as a set of typed remote procedure call traits and the executor 120 can enforce that layer code in the sandbox environment 210 can reach the external resource(s) 150 through those typed interfaces, with no direct resource access path available to the layer code. For example, when the executor 120 loads one of the capabilities 140 from the repositories 110 and instantiates it alongside a sandboxed layer, the interface can be established by transmitting the defined call interface 220 to the layer before the first main call is issued, such that the layer's available operations can be bounded by the typed interface prior to any execution. Step 360 can occur as part of pipeline generation and capability loading, such that the interface can be established before the executor 120 begins invoking layer stages and transmitting calls.

The executor 120 can generate the interface by transmitting the defined call interface 220 associated with the capabilities 140 to the layers 130, providing access to at least one of the external resource(s) 150 via the capabilities 140 based on the defined call interface 220, and preventing access by the layers 130 to the external resource(s) 150 outside the defined call interface 220. In some implementations, in an open evaluation environment, the defined call interface 220 can accept user-submitted code, the user-submitted code can invoke an auxiliary large language model (LLM) capability subject to server-side restrictions on call count and input size without exposing the surrounding system to unconstrained access. For example, when a user submits evaluation code through a web interface, the executor 120 can compile the code to WebAssembly, load it into the sandbox environment 210, and generate an interface that exposes a single LLM capability whose implementation limits callers to one invocation with fewer than a defined character limit, with those restrictions embedded in the capability and not editable within the submitted layer code.

The method 300 can include generating logging data (step 370). Logging data can be generated by the layered security testing and AI evaluation system 102 associated with execution of the pipeline, correlating activity of the executor 120, the layers 130, and the capabilities 140 into a unified audit record that documents all operations performed during pipeline execution. For example, the logging data can capture the sequence of main calls from the executor 120 to each of the layers 130, the remote procedure calls from each of the layers 130 to each of the capabilities 140, serialized input and output data at each stage boundary, and any rate-limiting events that occurred during execution of the pipeline. Step 370 can occur throughout execution of the pipeline and can be performed continuously alongside steps 350 and 360, so that the logging record reflects the complete runtime state of the executor 120, the layers 130, and the capabilities 140 from instantiation through completion. In some implementations, logging data can begin to be generated at step 310 when the executor 120 is instantiated and binary signatures can be verified, and can continue to be generated through each stage of the pipeline until the final output is generated and written to an output file. The logging data can be generated preserving execution context using instrumentation such as OpenTelemetry-based instrumentation that correlates telemetry spans across the executor 120, the layers 130, and the capabilities 140, facilitating post-execution analysis of all operations. For example, when a pipeline executes an attack chain over a large dataset, the logging data can record per-stage telemetry including input size, output values, and capability call latency, providing a complete audit trail that a security researcher can use to verify the correctness and integrity of the pipeline execution. In some implementations, logging data and debugging data generated during execution of a layer can support analysis or refinement of a later version of agent-related logic or evaluation logic. For example, when a layer associated with an AI agent or LLM agent returns an incomplete result, returns an error, or otherwise does not satisfy an evaluation objective, execution context preserved in the logging data and debugging data can be used in connection with a later version of the logic while maintaining the same interface boundary between the layer and the one or more capabilities 140.

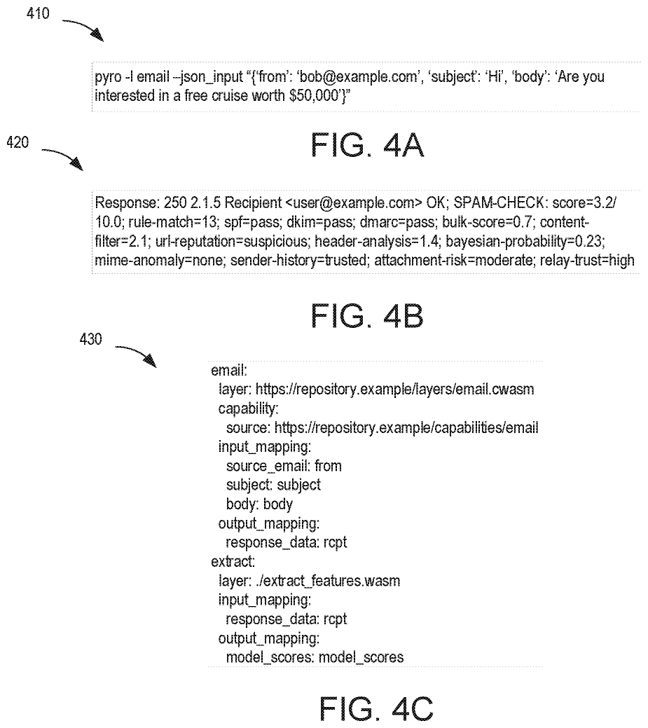

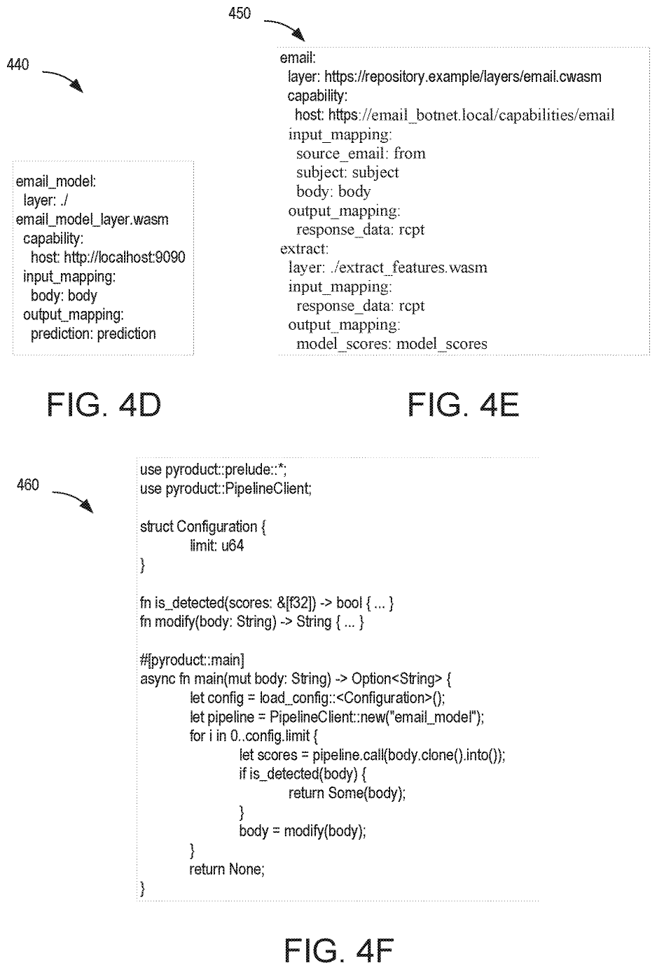

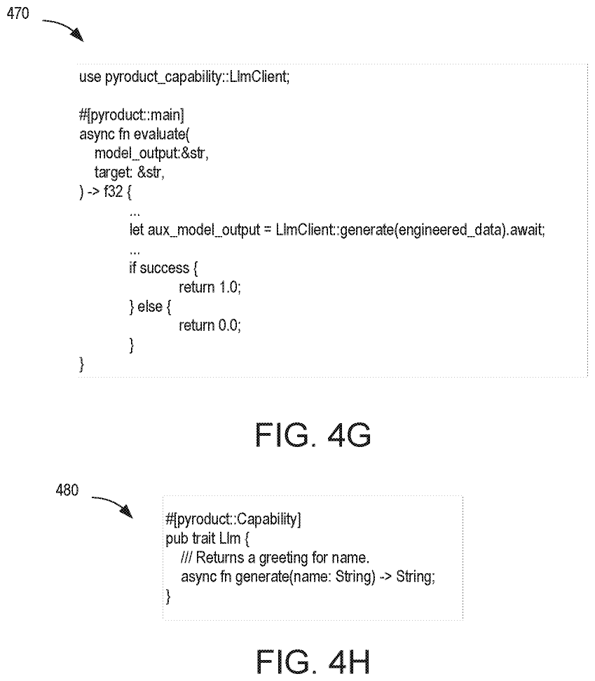

Referring now to FIG. 4A, illustrated is an example command-line invocation execute executor code snapshot 410 for executing a layer associated with an email capability, illustrated as a command-line interface format.

The execute executor code snapshot 410 can represent a command-line invocation that causes the executor 120 to execute at least one layer associated with an email capability and generate output and logs based on input data provided at the command line. In some implementations, the execute executor code snapshot 410 can reference a repository-hosted layer, a locally provided layer, or both, and can support iterative testing by allowing a user to vary layer selection or inputs across successive invocations without changing an underlying pipeline-definition file.

Referring now to FIG. 4B, illustrated is an example response output, response output code snapshot 420 returns from execution of the executor 120, illustrated as a text-based protocol response format.

The response output code snapshot 420 can represent response data returned by a capability and provided to the executor 120 and a downstream layer for processing. In some implementations, the response output code snapshot 420 can encode structured information generated by an external system and can be parsed by a layer to generate structured values used as intermediate outputs or inputs to later stages of a pipeline.

Referring now to FIG. 4C, illustrated is an example YAML pipeline definition, YAML pipeline definition code snapshot 430 links layers and capabilities, illustrated as a YAML configuration format.

The YAML pipeline definition code snapshot 430 can represent configuration data defining a multi-stage pipeline, including identification of layers and capabilities and specification of input mappings and output mappings used to route data between stages. In some implementations, the YAML pipeline definition code snapshot 430 can further specify source locations for layers and capabilities and transport data used for communication between layers and capabilities during execution.

Referring now to FIG. 4D, illustrated is an example attack phase process, attack phase process code snapshot 440 can be for local execution of a capability associated with a stolen model, illustrated as a YAML configuration format.

The attack phase process code snapshot 440 can represent a pipeline definition that configures execution of a capability through a local endpoint and maps inputs and outputs for generating a prediction or score used in an attack-chain or evaluation workflow. In some implementations, the attack phase process code snapshot 440 can define a named pipeline usable as a sub-pipeline callable by a layer through a pipeline call interface.

Referring now to FIG. 4E, illustrated is an example email extraction pipeline, email extraction pipeline code snapshot 450 links layers and capabilities for remote execution of a capability through a host specification, illustrated as a YAML configuration format.

The email extraction pipeline code snapshot 450 can represent a pipeline definition that configures remote execution of a capability by specifying a host endpoint, allowing the pipeline to be executed with a remotely hosted capability. In some implementations, the email extraction pipeline code snapshot 450 can be reused without modification to layer logic or mappings while switching a capability between local execution and remote execution by changing configuration fields associated with the capability.

Referring now to FIG. 4F, illustrated is an example layer, layer code snapshot 460 is for iteratively modifying input data and invoking a pipeline through a pipeline call interface, illustrated as a source-code format.

The layer code snapshot 460 can represent a layer implementation that executes iterative logic and calls a named pipeline or sub-pipeline through a pipeline call interface, repeated evaluation of modified inputs to achieve an objective can occur. In some implementations, the layer code snapshot 460 can execute within a sandbox environment and can call the sub-pipeline through the executor 120 while external resource access remains mediated through capabilities.

Referring now to FIG. 4G, illustrated is an example layer, layer code snapshot 470 is for evaluation of model output using a capability configured to provide access to an auxiliary large language model, illustrated as a source-code format.

The layer code snapshot 470 can represent a layer implementation that executes an evaluation routine and calls an auxiliary large language model capability through the defined call interface to generate an evaluation result. In some implementations, the layer code snapshot 470 can be user-submitted and executed in a sandbox environment while auxiliary large language model access is mediated and restricted through the capability implementation.

Referring now to FIG. 4H, illustrated is an example capability code snapshot 480 for a large language model capability, illustrated as a source-code interface definition format.

The capability code snapshot 480 can represent a capability interface definition defining permitted calls to a large language model capability exposed to layers through the defined call interface. In some implementations, a capability implementation corresponding to the capability code snapshot 480 can enforce call-count restrictions, input-size restrictions, or other access restrictions independently of layer logic executing in the sandbox environment. In some implementations, the layer code snapshot 470 and the capability code snapshot 480 can be used together in an evaluation environment configured to evaluate behavior of an AI agent, including an LLM agent. The layer code snapshot 470 can implement evaluation logic that processes output generated by the AI agent, and the capability code snapshot 480 can define restricted auxiliary large language model access available to the evaluation logic through the defined call interface. In such implementations, the executor 120 can generate logging data associated with execution of the evaluation logic to support auditing and analysis of agent behavior.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

Some non-limiting embodiments of the present disclosure are described herein in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open ended terms. Further, the phrase “based on” is intended to mean “based at least partially on” unless explicitly stated otherwise.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A system for layered security testing and Artificial Intelligence (AI) evaluation, the system comprising:
at least one processing resource; and
a computer-readable medium storing instructions that, when executed by the at least one processing resource, cause the system to:
instantiate an executor configured to orchestrate execution of a plurality of layers and a plurality of capabilities;
determine the plurality of layers, the plurality of layers comprising user-defined logic configured for execution in a sandbox environment and defining at least one of security test logic and AI evaluation logic;
determine the plurality of capabilities, the plurality of capabilities comprising executable code configured to provide controlled access to at least one of a plurality of external resources;
generate a pipeline linking at least one of the plurality of layers with at least one of the plurality of capabilities according to configuration data defining input mappings, output mappings, and transport data;
transmit, via the pipeline, a call from at least one of the plurality of layers to at least one of the plurality of capabilities;
generate an interface between the plurality of layers and at least one of the plurality of external resources, the interface configured to mediate access through the plurality of capabilities; and
generate logging data associated with execution of the pipeline.

2. The system of claim 1, wherein instantiating the executor comprises:
retrieving at least one of the plurality of layers and at least one of the plurality of capabilities from one or more repositories;
determining binary signature data associated with at least one of the plurality of layers and at least one of the plurality of capabilities; and
authorizing execution of at least one of the plurality of layers and at least one of the plurality of capabilities based at least on the binary signature data.

3. The system of claim 1, wherein determining the plurality of layers comprises:
identifying user-defined logic written in at least one programming language;
generating, based on the user-defined logic, a compiled representation configured for execution in the sandbox environment; and
transmitting, to the pipeline, the compiled representation for execution in the pipeline.

4. The system of claim 3, wherein determining the plurality of layers further comprises:
identifying a first layer configured for execution in the sandbox environment and a second layer configured for native execution;
selecting the first layer for a first execution context associated with a first security level; and
selecting the second layer for a second execution context associated with a second security level, wherein the second security level is lower than the first security level.

5. The system of claim 1, wherein determining the plurality of capabilities comprises:
identifying a first capability configured for local execution by dynamic loading in the executor;
identifying a second capability configured for remote execution through a communication channel to at least one of a remote server and a remote executor; and
selecting the first capability or the second capability according to the transport data.

6. The system of claim 1, wherein generating the pipeline comprises:
identifying, based on the configuration data, a first layer, a second layer, and a first capability;
mapping an output of the first layer to an input of the first capability according to the input mappings;
mapping an output of the first capability to an input of the second layer according to the output mappings; and
linking the first layer, the first capability, and the second layer in a processing sequence.

7. The system of claim 1, wherein transmitting the call via the pipeline comprises:
generating a remote procedure call from at least one of the plurality of layers to at least one of the plurality of capabilities;
serializing data associated with the remote procedure call according to a serialization format; and
communicating the serialized data according to a transport specified by the transport data.

8. The system of claim 1, wherein generating the interface comprises:
transmitting, to the plurality of layers, a defined call interface associated with the plurality of capabilities;
providing, via the plurality of capabilities, based on the defined call interface, access to at least one of the plurality of external resources; and
preventing access by the plurality of layers to the plurality of external resources outside the defined call interface.

9. The system of claim 1, wherein the executor is further configured to manage execution of the pipeline by:
executing at least one execution control comprising at least one of rate limiting, load balancing, and access restriction to a call directed to at least one of the plurality of capabilities;
verifying authorization associated with access to at least one of the plurality of layers or at least one of the plurality of capabilities; and
determining debugging data associated with execution of the pipeline.

10. The system of claim 1, wherein the plurality of capabilities comprise executable code configured to provide controlled access to at least one resource, and wherein generating logging data further comprises correlating activity of the executor, the plurality of layers, and the plurality of capabilities.

11. The system of claim 1, wherein the executor is further configured to:
generate a second pipeline;
expose the second pipeline to at least one of the plurality of layers through a pipeline call interface; and
execute the second pipeline in response to a call from at least one of the plurality of layers.

12. A method for layered security testing and Artificial Intelligence (AI) evaluation, the method comprising:
instantiating an executor configured to orchestrate execution of a plurality of layers and a plurality of capabilities;
determining the plurality of layers, the plurality of layers comprising user-defined logic configured for execution in a sandbox environment and defining at least one of security test logic and AI evaluation logic;
determining the plurality of capabilities, the plurality of capabilities comprising executable code configured to provide controlled access to at least one of a plurality of external resources;
generating a pipeline linking at least one of the plurality of layers with at least one of the plurality of capabilities according to configuration data defining input mappings, output mappings, and transport data;
transmitting, via the pipeline, a call from at least one of the plurality of layers to at least one of the plurality of capabilities;
generating an interface between the plurality of layers and at least one of the plurality of external resources, the interface configured to mediate access through the plurality of capabilities; and
generating logging data associated with execution of the pipeline.

13. The method of claim 12, wherein determining the plurality of layers comprises:
receiving user-defined logic through an interface associated with an evaluation environment;
identifying the user-defined logic as logic written in at least one programming language;
generating, based on the user-defined logic, a compiled representation configured for execution in the sandbox environment; and
transmitting, to the pipeline, the compiled representation for execution in the pipeline.

14. The method of claim 12, wherein generating the pipeline comprises:
receiving a pipeline definition in a configuration format;
identifying, from the pipeline definition, source data associated with at least one of the plurality of capabilities;
replacing the source data with host data associated with a remote server; and
executing the pipeline with the remote server while maintaining at least one of the plurality of layers in the pipeline.

15. The method of claim 12, further comprising:
executing the pipeline in a command-line interface environment;
receiving input data from a command-line invocation; and
generating result data associated with execution of the pipeline in the command-line interface environment.

16. The method of claim 12, further comprising:
executing the pipeline in a server environment;
determining data from a storage mechanism for processing by the pipeline; and
generating result data associated with execution of the pipeline in the server environment.

17. The method of claim 12, further comprising:
generating a second pipeline;
exposing the second pipeline to at least one of the plurality of layers through a pipeline call interface; and
executing the second pipeline in response to a call from at least one of the plurality of layers.

18. The method of claim 12, wherein determining the plurality of capabilities comprises determining a capability configured to provide access to a large language model, and wherein mediating access comprises:
limiting a number of calls from user-defined logic to the capability configured to provide access to the large language model to a single call during execution of the pipeline; and
limiting an amount of input data provided to the capability configured to provide access to the large language model to fewer than a limit of characters during execution of the pipeline.

19. A non-transitory, computer-readable medium comprising instructions that, when executed by at least one processing resource, cause the at least one processing resource to:
instantiate an executor configured to orchestrate execution of a plurality of layers and a plurality of capabilities;
determine the plurality of layers, the plurality of layers comprising user-defined logic configured for execution in a sandbox environment and defining at least one of security test logic and Artificial Intelligence (AI) evaluation logic;
determine the plurality of capabilities, the plurality of capabilities comprising executable code configured to provide controlled access to at least one of a plurality of external resources;
generate a pipeline linking at least one of the plurality of layers with at least one of the plurality of capabilities according to configuration data defining input mappings, output mappings, and transport data;
transmit, via the pipeline, a call from at least one of the plurality of layers to at least one of the plurality of capabilities;
generate an interface between the plurality of layers and at least one of the plurality of external resources, the interface configured to mediate access through the plurality of capabilities; and
generate logging data associated with execution of the pipeline.

20. The non-transitory, computer-readable medium of claim 19, wherein the instructions, when executed by the at least one processing resource, further cause the at least one processing resource to:
receive user-defined logic through an interface associated with an evaluation environment;
generate, based on the user-defined logic, a compiled representation configured for execution in the sandbox environment;
transmit, to the pipeline, the compiled representation for execution in the pipeline;
determine a capability configured to provide access to a large language model; and
limit, through the capability, at least one of a number of calls and an amount of input data associated with access to the large language model during execution of the pipeline.
